(19) United States
(12) Patent Application Publication
(10) Pub. No.: US 2024/0137920 A1
(43) Pub. Date: Apr. 25, 2024

(54) SYSTEMS AND METHODS FOR A WIRELESS BROADBAND ACCESS SYSTEM

(71) Applicant: Ahmad Jalali, Rancho Santa Fe, CA (US)

(72) Inventor: Ahmad Jalali, Rancho Santa Fe, CA (US)

(21) Appl. No.: 18/383,224

(22) Filed: Oct. 23, 2023

Related U.S. Application Data
(60) Provisional application No. 63/419,068, filed on Oct. 25, 2022.

(51) Int. Cl. H04W 72/0453; H04W 72/541

(52) U.S. Cl. CPC H04W 72/0453; H04W 72/541

(57) ABSTRACT

A communications apparatus comprises of one or more Active Antenna Units (AAUs) collocated in the same sector, and a processor. The processor de-multiplexes a data packet stream into at least two sub-streams, each sub-stream is transmitted on a different medium path. Each medium path is comprised of frequency channels, antenna polarizations and AAUs. A scheduler assigns data packets to different medium paths. The apparatus transmits on at least one frequency band, each frequency band is divided into a set of one or more frequency channels, at least one frequency channel of a frequency band is assigned to at least one AAU. A frequency channel is assigned to only one or to both antenna polarizations of the same AAU. The apparatus determines if an extraneous signal is present on a frequency channel and stops transmitting on the entire or part of the frequency channel where extraneous signal is detected.

### CROSS-REFERENCE

This application claims priority to co-owned and co-pending U.S. Application Ser. No. 63/419,068 filed Oct. 25, 2022 entitled: “SYSTEMS AND METHODS FOR A WIRELESS BROADBAND ACCESS SYSTEM”, the contents of which are incorporated by reference in their entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present disclosure describes aspects of a wireless communications system comprising a network of Base Stations (BSs) to provide wireless broadband access to User Equipment (UE). The disclosure describes systems and methods to mitigate the loss of frequency channels due to the priority use of the frequency channels by other services, to mitigate the co-channel interference from transmitters of other systems, to mitigate the co-channel interference from other beams or sectors within the same system, and to increase EIRP, to overcome interference and propagations losses.

### BACKGROUND OF THE INVENTION

High speed and robust wireless broadband internet access to UEs such as smart phones, to communications devices for vehicles and aircraft, and to Customer Premises Equipment (CPE) for fixed wireless broadband access to premises such as houses, and enterprises continues to be an active area of research and development. Frequency bands from below 7 GHz and in the mmwave range are being considered for 5G systems and beyond.

5G and future wireless broadband systems aim at providing data rates of 1 Gbps or higher to UEs, with low delay and high reliability. The BSs achieve such high data rates to substantial number of UEs by using large Multi-User Multiple Input Multiple Output (MU-MIMO) systems and multiple frequency bands, wherein the BSs form many narrow beams, and the BSs point each beam toward at least one UE. These systems use both licensed and unlicensed bands. Examples of unlicensed bands are the so-called U-NII-1, U-NII-2A, U-NII-2C and U-NII-3 bands in the 5 GHz band, as well as the U-NII-5 to U-NII-8 bands in the 6 GHz band. Other examples are the ISM band in the 2.4 GHz band, and the 57-71 GHz band. The frequency bands where multiple users share the channel by first sensing if the channel is occupied by other users and then transmitting if the channel is not being used are also referred to as shared channels, such as parts of the CBRS band from 3.55 to 3.7 GHz or the U-NII-5 and 1-NII-7 bands. A person of ordinary skill in the art will recognize that the systems and methods described in this disclosure for unlicensed bands are also applicable to shared bands, without departing from the scope of the disclosure.

There are several challenges in using unlicensed and shared bands, while achieving a robust broadband service. The users of unlicensed band may receive co-channel interference from other users in the same band, which may impact their data rates. Therefore, systems and methods are needed to mitigate the effects of co-channel interference, to maintain a robust broadband link. Users of some of the shared/unlicensed frequency bands must give priority to the incumbent users. For instance, the Navy occasionally transmits radar signals on parts of the U-NII-2A and U-NII-2C bands. The users of these bands must implement Dynamic Frequency Selection (DFS) to monitor the frequency bands for the existence of radar signals and to vacate a frequency channel upon detection of a radar signal in the frequency channel. The U-NII-5 and U-NII-7 users will have to protect incumbent users such as the microwave links or radio astronomy, by using an Automated Frequency Coordination (AFC) system to avoid transmitting on a frequency channel that the incumbent services are using. Therefore, systems and methods are needed to avoid transmitting in parts of the band that the incumbent services are using, while achieving a reliable and high data rate link.

### BRIEF DESCRIPTION OF THE SEVERAL VIEWS OF THE DRAWINGS

Some embodiments of the present invention are illustrated as an example and are not limited by the accompanying FIGURES. In the following FIGURES, where appropriate, similar components are identified using the same reference label.

FIG. 1A is a graphical depiction of an exemplary Antenna Unit (AU) structure, according to some embodiments.

FIG. 1B is a graphical depiction of an exemplary AU structure, according to some embodiments.

FIG. 1C is a graphical depiction of an exemplary AU structure, according to some embodiments.

FIG. 2A is a graphical depiction of an exemplary BS or UE communications apparatus, according to some embodiments.

FIG. 2B is a graphical depiction of an exemplary BS or UE Active Antenna Unit (AAU) apparatus, according to some embodiments.

FIG. 2C is a graphical depiction of an exemplary BS or UE multi-frequency-channel radio transceiver apparatus unit, according to some embodiments.

FIG. 2D is a graphical depiction of an exemplary BS or UE AAU apparatus, according to some embodiments.

FIG. 3A is a graphical depiction of a Collocated Distributed AAU (CD-AAU) apparatus, according to some embodiments.

FIG. 3B is a graphical depiction of a CD-AAU apparatus, according to some embodiments.

FIG. 3C is a graphical depiction of a CD-AAU apparatus, according to some embodiments.

FIG. 3D is a graphical depiction of a CD-AAU apparatus, according to some embodiments.

FIG. 4A is a graphical depiction of an adaptive frequency channel aggregation transmitter, according to some embodiments.

FIG. 4B is a graphical depiction of an adaptive frequency channel aggregation transmitter, according to some embodiments.

FIG. 5A is a graphical depiction of an adaptive frequency channel aggregation receiver, according to some embodiments.

FIG. 5B is a graphical depiction of an adaptive frequency channel aggregation receiver, according to some embodiments.

FIG. 6A is a graphical depiction of a BS communications apparatus, according to some embodiments.

FIG. 6B is a graphical depiction of a UE communications apparatus, according to some embodiments.

FIG. 6C is a graphical depiction of a BS cell site equipment, according to some embodiments.

FIG. 6D is a graphical depiction of an Integrated Access and Backhaul BS (IAB-BS) cell site equipment, according to some embodiments.

FIG. 6E is a graphical depiction of a two-node relay network, according to some embodiments.

### SUMMARY

A communications apparatus is described that enables wireless broadband access using a set of frequency channels on several frequency bands, where some frequency channels may, at certain times, become unavailable as the incumbent services use the frequency channels, or due to the interference from other users of the frequency bands. Systems and methods are described to adapt to the changes in the availability of the frequency channels and to the level of interference on the frequency channels, to provide a robust broadband access service.

The communications apparatus comprises of at least one Active Antenna Unit (AAU) and a processor. In some embodiments, a plurality of AAUs is collocated in the communications apparatus at the same sector of a cell site. Each AAU comprises of at least one antenna element, each antenna element comprises of at least one antenna polarization, each antenna element is connected to a radio subsystem, and the radio subsystem is connected to the processor.

A transmit medium unit comprises of three elements, one frequency channel, one antenna polarization and one active antenna unit. A sub-stream medium path comprises of at least one transmit medium unit. Two transmit medium units are different if at least one element of the two transmit medium units is different. Two sub-stream medium paths are different if they comprise of different transmit medium units. In some embodiments, the processor de-multiplexes a user data packet stream into at least two data packet sub-streams. Each data packet sub-stream is transmitted on a different sub-stream medium path.

In some embodiments, the processor comprises of a baseband processor. The baseband processor searches for the existence of an extraneous signal on at least one frequency channel. The communications apparatus stops transmitting on the frequency channel, or a part of the frequency channel, on which an extraneous signal is detected, while transmitting data on the remaining available frequency channels. The transmission of the user data packet stream on multiple sub-stream medium paths provides a high degree of diversity. If some frequency channels become unavailable, or receive high interference, the user data packet stream is still transmitted over the remaining frequency channels of the sub-stream medium paths. In some embodiments, the processor comprises of a scheduler that assigns the data packets of the user data packet stream to the sub-stream medium paths such as to maximize overall sector data throughput.

In one embodiment, the communications apparatus transmits and receives on a set of one or more frequency bands, each frequency band is divided into a set of one or more frequency channels, at least one frequency channel of the set of one or more frequency channels of a frequency band is assigned to at least one AAU. In a variation of the embodiment, a frequency channel is assigned to the AAUs that comprise of only one antenna polarization of the same AAU.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, as the scope of the invention is best defined by the appended claims. Various inventive features are described below that can each be used independently of one another, or in combination with other features.

A network of Base Stations (BSs) provides broadband connectivity to User Equipment (UE). Each BS/UE comprises of at least one radio subsystem connected to at least one Antenna Unit (AU), each AU is further comprised of at least one row and at least one column of antenna elements. The radio subsystem can form multiple simultaneous beams, and enables each AU to form at least one beam within the sector covering the azimuthal and elevation angular view of the AU. In some embodiments, the radio subsystem is integrated with the AU. The BS assigns each BS beam to at least one UE. The BSs may be installed on a tower, on a building, on aerial platforms such as drones and aircraft, or on satellites.

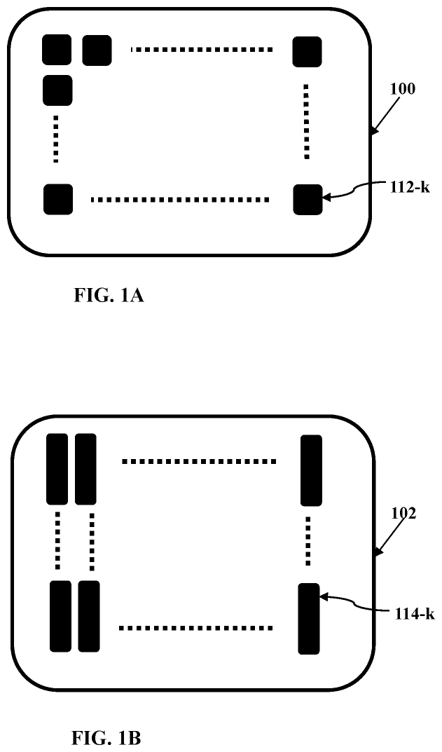

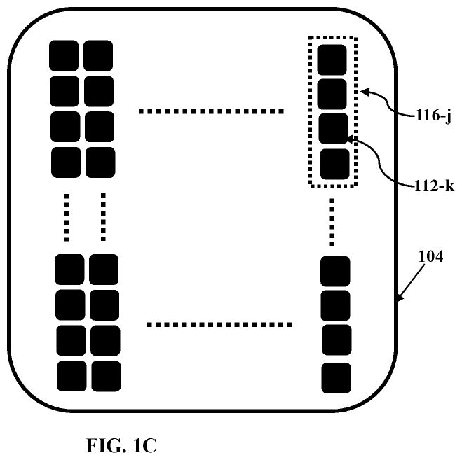

The BSs and the UEs may generate beams using digital beamforming, analog beamforming, or a hybrid of analog and digital beamforming. FIG. 1A illustrates an exemplary AU 100 that comprises of at least one row and at least one column of antenna elements 112-k, k an integer ≥1. In one embodiment, antenna elements 112-k are spaced at half wavelength. In one embodiment, digital beamforming implementation is used to apply the azimuth and elevation beamformer coefficients to the antenna elements of AU 100 of FIG. 1A. In another embodiment, digital beamforming is used to apply the azimuth beamformer coefficients to the antenna elements in the columns of AU 100, and analog beamforming is used to apply the elevation beamformer coefficients to the antenna elements in the rows of AU 100 of FIG. 1A. FIG. 1B illustrates an exemplary AU 102 comprised of antenna elements 114-k, k an integer ≥1, that are longer in the y-direction (elevation) and are shorter in the x-direction (azimuth). In one embodiment, digital beamforming is used to implement the azimuth and elevation beamformer coefficients of the exemplary AU 102 of FIG. 1B. In one embodiment, antenna elements 114-k are spaced at half wavelength in each row.

FIG. 1C illustrates an exemplary AU 104, wherein several antenna elements of the type 112-k, k an integer ≥1, are grouped in the y-direction to form antenna sub-apertures 116-j, j an integer ≥1. In one embodiment of the beamforming implementation for the exemplary AU of FIG. 1C, digital beamforming is used to apply the azimuth beamformer coefficients to the antenna sub-apertures 116-j, and hybrid beamforming is used in the elevation direction wherein the elevation beamformer coefficients are further divided into a product of a first and a second set of elevation beamformer coefficients. In a variation of the embodiment, the first set of elevation beamformer coefficients are applied to the elements 112-k within an antenna sub-aperture 116-j using analog beamforming, to tilt the beam toward one of a first set of elevation angles, and the second set of elevation beamformer coefficients are applied to the antenna sub-apertures 116-j using digital beamforming, to steer the beam in elevation within a range of elevation angles around one of the first set of elevation angles. The antenna elements 112-k and 114-k may have dual polarization, such as horizontal and vertical polarizations, cross polarizations, or left and right circular polarizations, or may have only one polarization.

In one embodiment, the BS transmits data simultaneously to multiple UEs using MU-MIMO schemes, wherein multiple simultaneous beams are formed by the BS and each beam is assigned for data transmission to one UE. In one variation of the embodiment, the BS beam toward each UE comprises of two beams, each beam is formed on one of the two antenna polarizations, and two data streams are transmitted to the UE, one data stream on each of the two beams. In another variation of the embodiment, the BS forms a beam toward a UE by placing the peak of the beam on the UE while placing nulls toward the other UEs, to minimize crossbeam interference and maximize SINR received on each beam.

### Active Antenna Unit

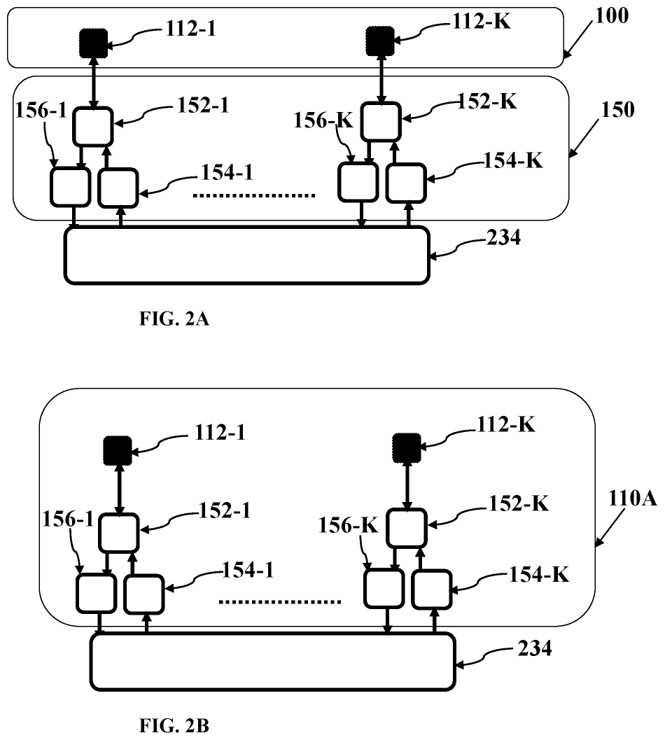

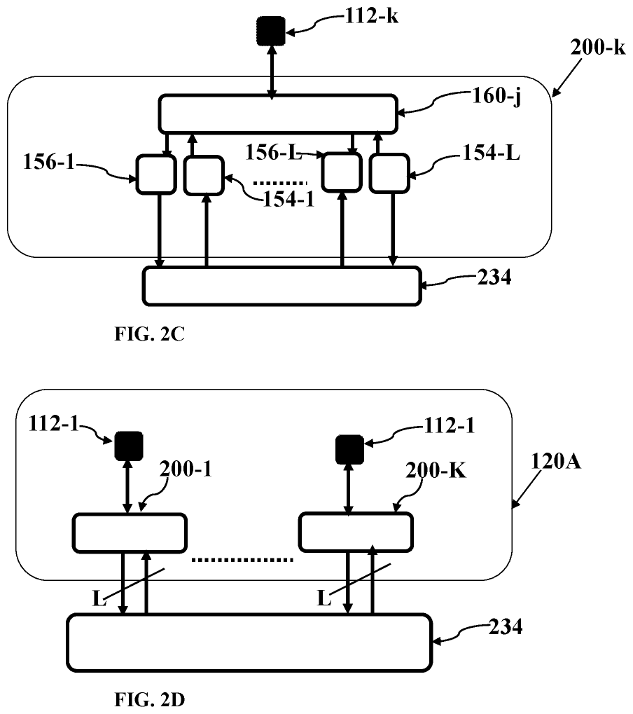

FIG. 2A illustrates an exemplary radio subsystem 150, where each antenna element 112-k, k an integer ≥1, of an AU 100 is connected to a device 152-k. In one embodiment, device 152-k is an RF switch that switches the antenna element from the transmit path to the receive path and vice versa in Time Division Duplex (TDD) systems and is a duplexer in Frequency Division Duplex (FDD) systems. Devices 152-k are connected to devices 154-k and 156-k. Devices 154-k and 156-k are connected to a baseband processor 234. Devices 154-k take digital I and Q samples from the baseband processor 234, do D/A and upconversion of the I and Q samples to a specific carrier frequency. Devices 156-k do downconversion and sampling of the analog signal received on each antenna element to generate digital baseband I and Q samples. In some embodiments, devices 154-k are followed by an analog filter. In some embodiments, devices 156-k are preceded by an analog filter. FIG. 2B illustrates an apparatus 110A, referred to as an Active Antenna Unit (AAU), wherein the radio transceiver components 152, 154 and 156 are included in the same hardware package as the antenna elements. A person of ordinary skill in the art will recognize that functionalities such as the upconversion of the baseband signal, and the downconversion and digital sampling of the analog signal by devices 152, 154 and 156 may be achieved by other combinations of devices or a single device, without departing from the scope of the disclosure.

FIG. 2C depicts an exemplary multi-frequency-channel radio transceiver unit 200-k, k an integer ≥1, which is capable of processing L baseband signals. Device 160-k of the radio transceiver unit 200-k comprises of a splitter that splits the received analog signal at the antenna element 112-k into L signals to be processed by the downconverter devices 156-k, a combiner that combines the L upconverted analog signals prior to the transmission of the signal on the antenna element 112-k, a duplexer for FDD systems, and a switch for TDD systems. FIG. 2D depicts a multi-frequency-channel AAU apparatus 120A, with L baseband channels, which comprises of antenna elements 112-k and multi-frequency-channel radio transceiver units 200-k. In FIG. 2D, and the remaining figures in the disclosure, a forward slash on an arrow implies the arrow carries multiple signals, where the number of signals is shown by the symbol next to the forward slash. A person of ordinary skill in the art will recognize that functionalities such as the upconversion of the multiple baseband signals, and the downconversion and digital sampling of the multiple analog signals by unit 200 may be provided by other combinations of devices or a single device, without departing from the scope of the disclosure.

### Beamforming Procedures

As a signal arrives at an antenna element and is processed from the antenna element through the downconversion path, the signal incurs receive path hardware induced phase and gain. Similarly, a baseband signal incurs transmit path hardware induced phase and a gain, as the signal is processed through the upconversion path and is transmitted through the antenna element. The hardware induced phases and gains on the receive and transmit paths are frequency dependent and depend on the characteristics of the electronics components, of the antenna elements and of the AAU. There is a frequency response for each transmit path, and for each receive path, associated with each antenna element of an AAU.

Beamforming algorithms, in systems such as MU-MIMO, form multiple beams, each beam has a different shape, where a different signal is transmitted or received on each beam. To form a certain beam shape and to transmit a signal on the beam, the beamforming algorithm applies a phase and a gain to the signal prior to the transmission of the signal on an antenna element, where the phases and gains applied to the signal are generally different for the different antenna elements. In some embodiments, digital beamforming signal processing is implemented in the complex domain, where a complex number αₖe^{iφ}^{ₖ}, referred to as the beamformer coefficient, is multiplied by the complex representation of the digital I and Q samples of the signal, where αₖ is the gain and φₖ is the phase of the beamformer coefficient for the k-th antenna element, and symbol i depicts imaginary number. In one embodiment, beamforming is carried out by dividing the signal destined for each antenna element by βₖe^{iθ}^{ₖ}, where βₖ and θₖ are the k-th transmit path hardware induced gain and phase, to undo the hardware induced gain and phase, and by multiplying the signal by the beamformer coefficient αₖ^{iφ}^{ₖ} for the k-th transmit path, prior to the transmission of the signal on the k-th antenna element.

Since the hardware induced phases and gains are frequency dependent, the process of undoing the hardware induced phases and gains needs to account for the frequency dependency. In one embodiment, an Orthogonal Frequency Division Multiplexing (OFDM) multiple access scheme is used, wherein the frequency channel is divided into a number of frequency tones, and the number of frequency tones is chosen such that the hardware induced phase and gain variation over the bandwidth of a frequency tone be small enough to use a single phase and gain pair to undo the hardware induced phase and gain of the frequency tone, while maintaining any signal distortion at the receiver below a certain threshold. For an OFDM waveform, the complex number representation of hardware induced phase and gain is denoted by βₖ^{iθ}^{ₖₗ}, where k is the index of the antenna elements and l is the index of the frequency tones. In one embodiment, a measurement process is used to estimate the hardware induced phase and gain pair for each frequency tone and antenna element pair. In one variation of the embodiment, the hardware induced phases and gains are measured on a subset of the frequency tones, and the hardware induced phases and gains for the remaining frequency tones are computed by interpolating the measured phase and gain values of the subset of the frequency tones. In one embodiment in an OFDM multiple access system, the hardware induced phase and gain on each frequency tone and antenna element pair is removed by dividing the signal for the m-th frequency tone destined for the k-th antenna element by βₖₗe^{iθ}^{ₖₗ}. In a variation of the embodiment, the signal is further multiplied by the beamformer coefficient αₖₗe^{iφ}^{ₖₗ} for the l-th frequency tone and k-th antenna element pair, to form beams according to the required beam shapes.

The above beamforming embodiments were described in the context of forming one beam and transmitting one signal on the beam. In a multi-beam embodiment, the BS forms multiple beams, a different signal is transmitted on each beam and a different set of beamformer coefficients are used for each beam. Let Sⱼ be the baseband complex number representation of the signal to be transmitted on the j-th beam, j an integer ≥1, and J, an integer ≥1, be the number of beams, αₖₗⱼe^{iφ}^{ₖₗⱼ} be the beamformer coefficient for the j-th signal, l-th frequency tone and k-th antenna element, and βₖₗe^{iθ}^{ₖₗ} be the complex representation of the transmit path hardware induced phase and gain for the m-th frequency tone and k-th antenna element. Then, the beamformed signal corresponding to the multiple signals to be transmitted on the 1-th frequency tone and k-th antenna element is given by Σⱼ₌₁^{j}αₖₗⱼe^{iφ}^{ₖₗⱼ}Sⱼ/(βₖₗe^{iθ}^{ₖₗ}.

In one embodiment, receive beamforming to recover the j-th signal on the m-th frequency tone is achieved by generating the sum Σₖ₌₁^{K}ρₖₗⱼe^{iω}^{ₖₗⱼ}Rₖₗⱼ/(γₖₗe^{iε}^{ₖₗ}), where ρₖₗⱼe^{iω}^{ₖₗⱼ} is the receive beamformer coefficient for the j-th signal on the k-th antenna element and 1-th frequency tone, K is the number of antenna elements, γₖₗe^{iε}^{ₖₗ} is the complex representation of the receive path hardware induced phase and gain, and Rₖₗⱼ is the received digital complex baseband signal sample for the j-th signal on the k-th antenna element and l-th frequency tone. The hardware induced phase and gain, and the beamformer coefficients, for the frequency tone and antenna element pairs may be different for the transmit and receive paths. In the previous embodiments, the beamforming systems and methods were described in the context of BS beamforming. A person of ordinary skill in the art will recognize that the systems and methods described in this disclosure for beamforming at the BS also apply to beamforming at the UE, without departing from the scope of the disclosure.

### Collocated Distributed AAU

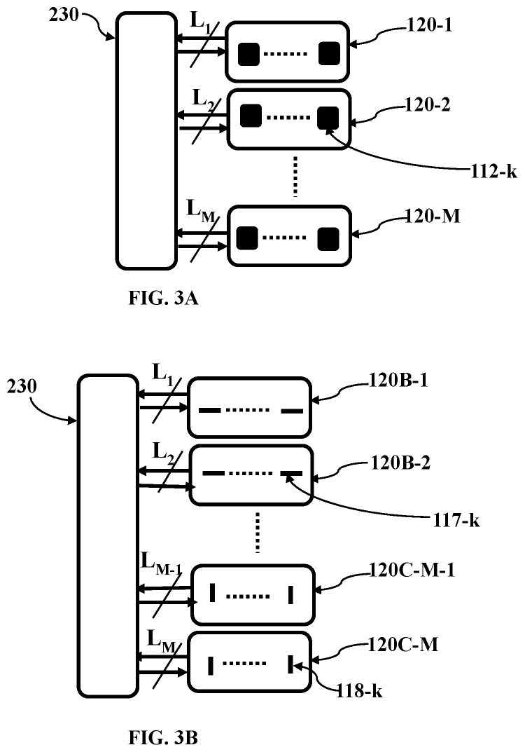

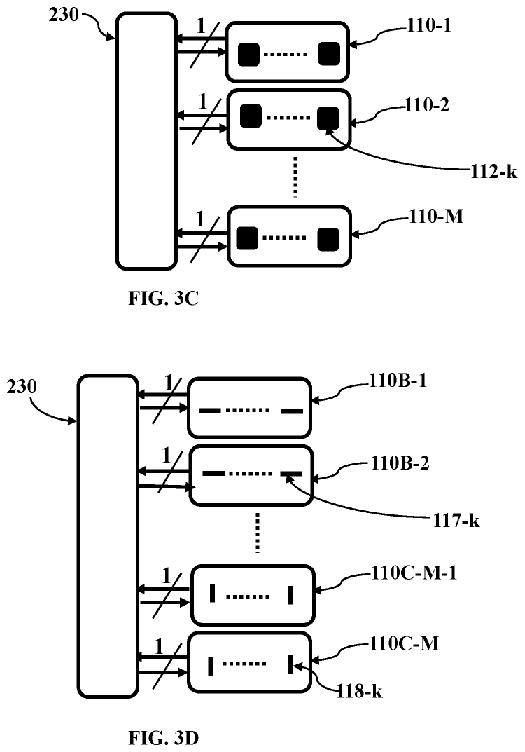

In one embodiment, the communications apparatus deployed at a sector of a cell site comprises of M AAUs, M an integer ≥1, referred to as a Collocated Distributed AAU (CD-AAU), and is depicted in FIGS. 3A, 3B, 3C and 3D. In FIG. 3A, the individual AAUs are denoted by 120-m, m an integer ≥1 and support Lₘ≥1 analog signals per AAU, where the AAUs 120-m incorporate a radio subsystem that carry out upconversion from at least one digital baseband signal to at least one analog signal and downconversion from at least one analog signal to at least one digital baseband signal for each antenna element. One exemplary AAU that implements the functionality of AAU 120 is illustrated by the AAU 120A of FIG. 2D. In FIG. 3C, the individual AAUs are denoted by 110-m, m an integer ≥1 and support Lₘ=1 analog signal per AAU, where the AAUs 110-m incorporate a radio subsystem that carry out upconversion of one digital baseband signal to one analog signal and downconversion of one analog signal to one digital baseband signal for each antenna element. One exemplary AAU that implements the functionality of 110 is illustrated by the AAU 110A of FIG. 2B.

In another embodiment, shown in FIG. 3B, the antenna elements of each AAU 120B or 120C comprise of a single polarization, horizontal and vertical polarizations denoted by 117-k and 118-k, k an integer ≥1, where AAUs 120B and 120C have the same structure and functionality as that of AAU 120A of FIG. 2D but use single polarization antenna elements. Other examples of antenna element polarizations that the apparatus of FIG. 3B may use are left or right cross polarized elements or left or right circularly polarized antenna elements. In another embodiment, shown in FIG. 3D, the antenna elements of each AAU 110B or 110C comprise of a single polarization, horizontal and vertical polarizations denoted by 117-k and 118-k, k an integer ≥1, where AAUs 110B and 110C have the same structure and functionality as that of AAU 110A of FIG. 2B but use single polarization antenna elements. The UE also comprises of a processor and a CD-AAU that have the same functionality as those of the BS processor and AAU. In some embodiments, the UE communications apparatus has a smaller number of component AAUs than the BS communications apparatus has and divides the available number of frequency channels among the smaller number of AAUs. FIGS. 3A, 3B, 3C and 3D illustrate a CD-AAU where multiple AAUs are spaced vertically at a cell site location. A person of ordinary skill in the art will recognize that other arrangements of multiple AAUs at a cell site such as in a row or in a two-dimensional grid are also possible, without departing from the scope of the disclosure.

### Adaptive Frequency Channel Aggregation

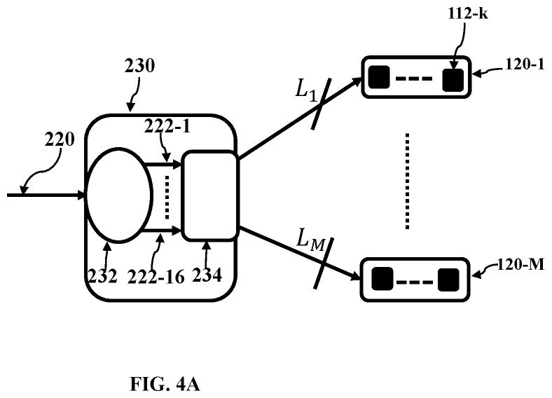

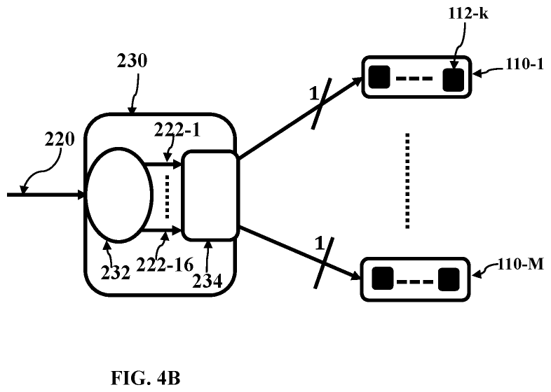

FIG. 4A illustrates a UE or a BS adaptive frequency channel aggregation apparatus that comprises of M AAUs 120-m, m and M integers ≥1, and a processor 230. FIG. 4B illustrates a UE or a BS adaptive frequency channel aggregation apparatus that comprises of M AAUs 110-m, m and M integers ≥1, and a processor 230. Henceforth, the embodiments in this disclosure are explained using the AAU apparatus 120 of FIG. 4A or AAU apparatus 110 of FIG. 4B. A person of ordinary skill in the art will recognize that the systems and methods described in this disclosure are also applicable to the apparatuses, such as illustrated in FIGS. 2A and 2C, wherein the radio transceiver components and antenna elements are in separate enclosures, or to apparatuses whose radio subsystems achieve the functionality of AAUs 110 and 120 but with a different set of complements, without departing from the scope of the disclosure.

The BS and UE processors are used to execute functionalities such as baseband processing of the user information to form a baseband signal, baseband processing of the received digital I and Q samples, data packet multiplexing, data packet de-multiplexing, data packet scheduling and upper layer protocol processing. The processor divides the received user information into a sequence of data packets and inserts a sequence number into each data packet that uniquely identifies the data packet. The processor 230 comprises of several subsystems, including a scheduler/de-multiplexer and a baseband processor 234. Let p=1, 2 denote the index of the two antenna polarizations of an AAU, and Nₚₘ denote the number of frequency channels that are assigned to the p-th antenna polarization of the m-th AAU. The BS scheduler/de-multiplexer 232 subsystem de-multiplexes the user data packet stream 220, to be transmitted to the UE, into N, an integer ≥1, data packet sub-streams 222-n, n an integer ≥1. In one embodiment, a data packet sub-stream is transmitted on one frequency channel, one antenna polarization and one AAU, in which case the total number of data packet sub-streams, N, that are transmitted on all the AAUs is given by N=Σₚ₌₁²ΣΣₘ₌₁^{M} Nₚₘ. In another embodiment, a data packet sub-stream may be transmitted on one or both antenna polarizations, one or more frequency channels and one or more AAUs, in which case the number of supported data packet sub-streams may be fewer than Σₚ₌₁²Σₘ₌₁^{M}Nₚₘ.

A transmit medium unit comprises of three elements, one frequency channel, one antenna polarization and one active antenna unit. Each frequency channel, antenna polarization and AAU is identified by an index. Each element of a transmit medium unit is identified by the index of the specific frequency channel, antenna polarization and the AAU that are assigned to the transmit medium unit. Two transmit medium units are different if at least one element of the two transmit medium units is different. A sub-stream medium path comprises of at least one transmit medium unit. Two sub-stream medium paths are different if the transmit medium units of a first sub-stream medium path are all different from the transmit medium units of the second sub-stream medium path. Each data packet sub-stream is transmitted on a different sub-stream medium path. The number of sub-stream medium paths is equal to the number of data packet sub-streams. Transmit medium units and sub-stream medium paths are constructed for the BS to UE data transmission direction (downlink) and for the UE to BE data transmission direction (uplink). In FDD systems, the transmit medium units for the downlink and uplink use different frequency channels corresponding to the downlink and uplink frequency bands. The number of AAUs, number of antenna element of each AAU, and the number of antenna polarizations of each AAU may be different for the CD-AAUs of the UE and the BS communications apparatuses. The transmit medium units and sub-stream medium paths of the BS are specified based on the CD-AAU characteristics of the BS, as well as the frequency bands and the frequency channelization of the frequency bands for transmission from the BS to the UE. Similarly, the transmit medium units and sub-stream medium paths of the UE are specified based on the CD-AAU characteristics of the UE, as well as the frequency bands and the frequency channelization of the frequency bands for transmission from the UE to the BS.

The scheduler determines the sub-stream medium path on which a given data packet will be transmitted and routes the data packet to the data packet sub-stream that is assigned to the corresponding sub-stream medium path. The baseband processor 234 determines a Modulation and Coding Scheme (MCS) for data transmission from the BS to a UE on the sub-stream medium path on which the data packet sub-stream is scheduled to be transmitted, adds error correction redundancy bits to the user information data based on the error correction code component of the MCS, computes coded symbols for each data packet based on the chosen MCS, and modulates all or a subset of the coded symbols onto the frequency channels of the sub-stream medium path. In one embodiment, the sub-stream medium path comprises of multiple transmit medium units, the coded symbols of a data packet are divided into multiple sets of coded symbols, one set of coded symbols for each transmit medium path, and the coded symbols of each of the multiple sets of coded symbols are modulated onto a frequency channel of a different transmit medium unit of the multiple transmit medium units. In another embodiment, a sub-stream medium path comprises of only one transmit medium unit, in which case a data packet is transmitted on the one frequency channel and antenna polarization of the medium transmit set.

In the embodiments where Lₘ≥2, the apparatus of FIG. A4 is employed. However, in the embodiments where Lₘ=1, the apparatus of FIG. 4A or 4B may be employed. In one embodiment, where Lₘ=1, but there are multiple baseband signals and each baseband signal corresponds to a different frequency channel, the baseband processor 234 adds all the baseband signals of each polarization and antenna element of an AAU 110 or 120 to form a single baseband signal for each polarization and antenna element of the AAU, the AAU upconverts the single baseband signal destined for each antenna polarization and antenna element and transmits each of the upconverted signals on a different one of the K antenna elements, or antenna polarizations, as shown in FIG. 2B.

In one embodiment, the baseband processor forms Lₘ≥2 baseband signals on the transmit side, for each antenna element of the AAU 120-m. The AAU 120-m upconverts each of the Lₘ baseband signals for each antenna element separately and combines the Lₘ upconverted signals for each antenna element prior to the transmission of the signal on a given antenna polarization and antenna element of the AAU. In some embodiments, each data packet sub-stream is transmitted on the frequency channels and antenna polarizations of one of the AAUs. In other embodiments, a data packet sub-stream may be transmitted on the frequency channels and antenna polarizations of multiple AAUs. In one embodiment, on the receive side, the m-th AAU splits the received signal on each antenna element into Lₘ signals, downconverts, samples and digitizes each signal on each antenna element into digital I and Q samples to generate Lₘ digitized I and Q sample streams on each antenna element. The processor carries out baseband signal processing on the received digital I and Q sample streams from all the antenna elements and antenna polarizations of all the AAUs and decodes the data packets carried by the L₁, . . . , Lₘ baseband signals.

The number of baseband signals, Lₘ, that are routed to the m-th AAU depends on the number of frequency channels available on the m-th AAU, the bandwidth of the frequency channels, the spacing of the frequency channels and the bandwidth of the upconverter/downconverter circuitry. In one embodiment, if the bandwidth occupied by all the available frequency channels, including any spacing between the frequency channels, is higher than the frequency bandwidth that the upconverter or downconverter circuitry are able to process, then the baseband signal corresponding to the aggregate of the frequency channels would be divided into a number of separate baseband signals so that the frequency bandwidth occupied by each resulting baseband signal be within the frequency bandwidth processing capability of the upconverter and downconverter circuitry of the AAU.

In one embodiment, the scheduler/de-multiplexer assigns data packets to each data packet sub-stream in a round robin manner by assigning one data packet to each data packet sub-stream. There may be a different amount of intra-system and inter-system interference on the different frequency channels or antenna polarizations, in which case the signal quality on the different frequency channel and antenna polarization pairs may be different, indicating some sub-stream medium paths may be able to carry more data packets than the other sub-stream medium paths do. In another embodiment, the scheduler assigns a different number of data packets to the different data packet sub-streams, wherein the number of data packets assigned to each data packet sub-stream is proportional to the data rate that the sub-stream medium path corresponding to the data packet sub-stream supports, while achieving a data packet error rate below a certain threshold. In a variation of the embodiment, the processor estimates the achievable data rate on each sub-stream medium path, computes a throughput ratio as the estimated achievable data rate on a given sub-stream medium path to the sum of the estimated achievable data rates of all the sub-stream medium paths, and sets the fraction of the data packets assigned to a sub-stream medium path equal to the throughput ratio computed for the sub-stream medium path. In another embodiment, the data packets for each data packet sub-stream are queued in a data packet sub-stream transmission buffer, the scheduler checks the queue size of each data packet sub-stream transmission buffer and assigns a data packet to a data packet sub-stream if the queue size of the data packet sub-stream transmission buffer is below a certain threshold. In a variation of the embodiment, the scheduler checks the queue size of each data packet sub-stream transmission buffer in a round robin manner. Since each data packet sub-stream is associated with one sub-stream medium path, the transmission buffer, and the associated queue size, of a data packet sub-stream are also associated with the sub-stream medium path corresponding to the data packet sub-stream.

The achievable data rate on each BS or UE sub-stream medium path depends on the intra-system co-channel interference from other beams and sectors within the system, and the inter-system co-channel interference from other systems. In one embodiment, the BS or the UE receiver estimates the received signal quality using the received reference symbols from the UE or the BS and uses the estimated received signal quality to determine the MCS to be used by the UE or the BS in data transmission on a given frequency channel, while maintaining probability of packet error below a certain threshold. In one variation of the embodiment, a sub-stream medium path is comprised of multiple frequency channels and the MCS of the sub-stream medium path is determined by using the average of the received signal qualities of the multiple frequency channels, wherein the same MCS is used on all frequency channels of the sub-stream medium path. In another variation of the embodiment, the BS or the UE chooses an MCS with the highest associated data rate, based on the received signal qualities of at least one frequency channel, such that the data packet error rate on the sub-stream medium path be below a certain threshold. In one embodiment, the BS or the UE informs the UE or the BS transmitter of the chosen MSC, and the UE or the BS transmitter transmits data using the determined MCS. Examples of signal quality measure are the average received Signal to Interference plus Noise Ratio (SINR) and the average received signal strength on each frequency channel of a sub-stream medium path. In an embodiment employing OFDM multiple access, the average signal quality is estimated by averaging the signal quality of the individual tones of the available frequency channels. In some embodiments, the receiver sends the estimated signal qualities to the transmitter, and the transmitter determines which MCS to use for data transmission based on the estimated signal qualities.

The number of information bits that are carried on each coded symbol of an MCS is equal to the MCS's error correction code rate times the number of bits that are carried on the modulation symbol of the MCS. In an OFDM multiple access system, a fraction of the frequency tones is assigned to the overhead signals such as the reference signals, paging and synchronization channels and other control channels, and the remaining fraction of the frequency tones carry user information. In an OFDM system, one estimate of the data rate on a frequency channel, associated with the MCS being used on the frequency channel, is obtained by multiplying the number of information bits carried on each coded symbol by the number of frequency tones of the frequency channel and by the fraction of the frequency tones that carry user information. In one embodiment, the processor chooses the data rate associated with an MCS on a sub-stream medium path as the achievable data rate on the sub-stream medium path. In another embodiment, the processor estimates the achievable data rate on a sub-stream medium path by making several measurements of data rate on that sub-stream medium path and by digital filtering of the measured data rates. Examples of digital filters are Finite Impulse Response (FIR) and Infinite Impulse Response (IIR) filters. In a variation of the embodiment, the achievable data rate on a sub-stream medium path is estimated by averaging the data rates measured on several recent data transmissions on that sub-stream medium path.

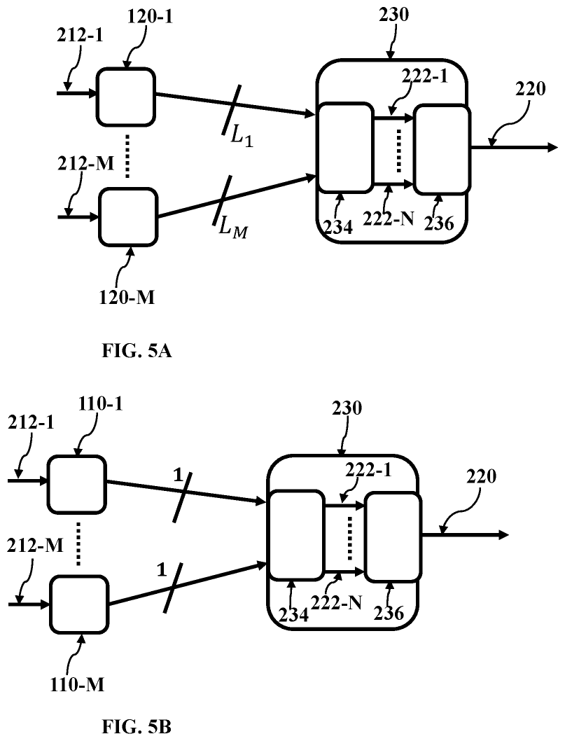

FIG. 5A shows a diagram of the UE receiver where the UE CD-AAU receives the radio signal 212-m on the AAU 120-m, each AAU 120-m downconverts the received signal 212-m to baseband digital I and Q samples and the baseband processor 234 demodulates and decodes the digital I and Q samples received from all the AAUs, to recover the data packet sub-streams that are transmitted by the AAUs of the BS. The UE processor comprises of a multiplexer 236. The multiplexer 236 multiplexes the N decoded data packet sub-streams 222-n back into the original user data packet stream 220. If a data packet of a data packet sub-stream that is received on a given sub-stream medium path is decoded correctly, then the decoded data packet is sent to an upper layer multiplexer protocol that multiplexes the data packets that are received in-sequence back into the original user data packet stream. If a data packet of a data packet sub-stream is received correctly but its data packet sequence number is not in-sequence with the data packets that have previously been received correctly and are in-sequence, then the data packet which is out of sequence will be kept in a separate buffer until the data packet becomes in-sequence with all the correctly received in-sequence data packets. FIG. 5B shows a diagram of the UE receiver where the UE CD-AAU receives the radio signal 212-m on the AAU 110-m. In the embodiments where Lₘ=1, the apparatus illustrated in FIG. 5B may be used as the UE receiver.

Data transmission from the UE to the BS follows the same procedures as that of the BS transmission to the UE, wherein the UE processor de-multiplexes the data stream destined for the BS into N data packet sub-streams and transmits each data packet sub-stream on a different UE sub-stream medium path, where the UE sub-stream medium path may comprise of one or two antenna polarizations, one or more frequency channels and one or more AAUs. The BS decodes the data packet sub-streams corresponding to the UE sub-stream medium path and sends the correctly decoded data packet to an upper layer multiplexer protocol where the data packets that are received correctly and are in-sequence are multiplexed back into the original data stream. A person of ordinary skill in the art will recognize that the systems and methods described in this disclosure for data transmission from BSs to UEs also apply to data transmission from UEs to BSs, without departing from the scope of the disclosure.

If the UE receiver does not correctly decode a data packet, the UE receiver informs the BS that the UE did not correctly decode the packet, and the BS uses a retransmission scheme to resend the data packet. In an incremental redundancy error recovery scheme, the BS transmitter adds error correction redundancy information to the user data packet information, computes a set of coded symbols using the combination of user data packet information, error correction redundancy information and the MCS being used on the sub-stream medium path on which the data packet is scheduled for transmission. The BS transmits a subset of the coded symbols on the first transmission of the data packet. If the receiver does not correctly decode the received first set of coded symbols, then the BS transmitter transmits additional coded symbols that were not previously transmitted to the UE, the UE uses all the received coded symbols from the previous and the latest transmissions to decode the data packet. The process of sending additional coded symbols continues until the UE correctly decodes the data packet or all the coded symbols have been transmitted. If all the coded symbols of a data packet have been transmitted and the data packet has not been decoded correctly, then the transmission of the data packet is repeated. A person of ordinary skill in the art will recognize that the systems and methods described in this disclosure for incremental redundancy error recovery scheme in data transmission from the BSs to the UEs also apply to data transmission from the UEs to the BSs, without departing from the scope of the disclosure.

In some frequency bands such as the U-NII-2A and U-NII-2C, the BS and UE must monitor each frequency channel for the existence of an extraneous signal being transmitted by an incumbent service, such as a radar signal from a Navy transmitter, and discontinue transmitting on the frequency channel if the extraneous signal is detected. In one embodiment for detecting an extraneous signal, the UE and the BS are equipped with a receiver that downconverts, samples and digitizes the received signal to generate the digital I and Q samples of the baseband signal and analyzes the digital I and Q samples to detect the existence of the extraneous signal. If the extraneous signal is detected on a frequency channel, then the UE or the BS that has detected the signal will inform the data packet scheduler to stop scheduling transmission of data packets on the frequency channel and instead route the data packets of the data packet sub-stream to other frequency channels. In one embodiment, the transmit medium units that comprise of a frequency channel on which the extraneous signal has been detected are removed from the sub-stream medium paths, in effect stopping transmission on the frequency channel as the sub-stream medium paths will not include a transmit medium unit that comprises of the frequency channel. If a sub-stream medium path comprises of only one transmit medium unit and the transmit medium unit is removed, in effect removing the sub-stream medium path, then the scheduler routes any data packets of the data packet sub-stream corresponding to the removed sub-stream media path to another sub-stream medium paths.

In some frequency unlicensed bands such as the U-NII-5 (5.925-6.425 GHz) and the U-NII-7 (6.525-6.875 GHz), the BS and the UE will provide the BS and the UE's transmitter location, elevation, and antenna characteristics to an AFC (Automatic Frequency Coordination) system, the AFC will determine if the transmissions by the BS or the UE on a frequency channel will cause harmful interference to an incumbent service and will inform the UE and the BS accordingly, and the UE or the BS will stop transmitting on the frequency channel, or a part of the frequency channel, if it has been informed of harmful interference to the incumbent service. In other shared frequency bands, the BS or the UE must monitor the frequency band for the existence of a signal from a higher priority user or another user and avoid transmitting on the part of the frequency band on which a higher priority or another user is transmitting/receiving. If the UE or the BS determines that it cannot transmit a data packet sub-stream on a given frequency channel, the data packet scheduler of the UE or of the BS will route the data packet sub-stream to one or more of the other available frequency channels. In one embodiment, the frequency channels that become unavailable are removed from the transmit medium units of the sub-stream medium paths of the UE or the BS. In a variation of the embodiment, a sub-stream medium path will be removed if all the frequency channels of the sub-stream medium path have become unavailable. In another variation of the embodiment, the scheduler continues to schedule data packets on the sub-stream medium paths that have not been removed.

In one embodiment, if an extraneous signal is present on a part of a frequency channel, then the corresponding part of the frequency channel becomes unavailable and the transmitter will stop transmitting on the unavailable part of the frequency channel, while transmitting on the remainder of the frequency channel. As an example, in an OFDM multiple access system, the available spectrum on a frequency channel is divided into several frequency tones and the coded symbols are transmitted on the frequency tones. In an OFDM multiple access system, if a part of the frequency channel becomes unavailable then the UE or the BS will stop transmitting coded symbols on the frequency tones in the part of the frequency channel that has become unavailable, while transmitting coded symbols on the remaining available frequency tones of the frequency channel. In a variation of the embodiment, the coded symbols that were to be transmitted on the frequency tones that have become unavailable are not transmitted on any frequency tones, and the remaining transmitted coded symbols on the available frequency tones are used at the receiver to decode the data packet. If the data packet is not correctly decoded, then additional coded symbols will be transmitted on the available frequency tones and all the received coded symbols from all the transmissions of the coded symbols of the same data packet will be used to decode the data packet.

### Assignment of Frequency Channels to AAUs

A frequency band is a contiguous interval of radio frequencies in the frequency domain. Two frequency bands may be adjacent to each other, where the upper limit of a first band is the same as the lower limit of the second band. Two different frequency bands may have different in-band power transmission emission limits, different out-of-band power transmission emission limits, or some other band specific transmission limitations. Examples of the unlicensed/shared frequency bands are the U-NII-1, U-NII-2A, U-NII-2C, U-NII-3, U-NII-5 to U-NII-8 bands and CBRS bands.

In one embodiment, the communications apparatus transmits on a set of one or more frequency bands, each frequency band is divided into a set of one or more frequency channels, at least one frequency channel of the set of one or more frequency channels of a frequency band of the set of one or more frequency bands is assigned to at least one AAU of a set of one or more AAUs. In a variation of the embodiment, a frequency channel is assigned to only one antenna polarization of the same AAU. The assignment of a frequency channel to an AAU is equivalent to including the frequency channel in at least one transmit medium unit that also comprises of the AAU. If a frequency channel is to be assigned to both antenna polarizations of the same AAU, then two transmit medium units are constructed, wherein each of the two transmit medium units comprise of the same frequency channel and the same AAU, a first transmit medium unit of the two transmit medium units comprises of a first antenna polarization and the second transmit medium unit of the two transmit medium units comprises of the second antenna polarization.

The maximum in-band Effective Isotropic Radiated Power (EIRP) allowed on different frequency bands may be different. The total conducted power from all the power amplifiers of an AAU may be limited for some frequency bands. The fraction of the total allowable conducted power allocated to each frequency channel must be determined so that the sum of the conducted powers from all frequency channels being transmitted on an AAU be below the maximum allowable conducted power limit of the AAU, while transmitting the maximum allowable EIRP on each frequency channel. In one embodiment, the sum of the maximum allowable EIRPs, in Watts, of all frequency channels being transmitted on an AAU is computed, and the fraction of the conducted power allocated to a frequency channel is set to the maximum allowable EIRP of the frequency channel, in Watts, to that of the sum of the maximum allowable EIRPs.

In one exemplary CD-AAU configuration, the CD-AAU of FIG. 4A comprises of four AAUs, i.e., M=4. In one exemplary division of frequency channels, a total of ten frequency channels, C1-C10, are henceforth specified within the U-NII-1 (5.15-5.25 GHz), U-NII-2A (5.25-5.35 GHz), U-NII-2C (5.47-5.725 GHz) and U-NII-3 (5.725-5.85 GHz) bands and are assigned to the four AAUs of the exemplary CD-AAU configuration. One exemplary division of the U-NII bands into frequency channels is: frequency channels C1 and C2 are 40 MHz and 60 MHz wide and cover the U-NII-I band; frequency channels C3 and C4 are 40 MHz and 60 MHz wide and cover the U-NII-2A band; frequency channels C5 through C8 cover part of the U-NII-2C band and are 60 MHz each; and frequency channels C9 and C10 cover part of the U-NII-3 band and are 60 MHz each. Frequency channels C1-C10 are transmitted on the four AAUs, providing a wide bandwidth system with a total spectrum of 560 MHz.

In one exemplary assignment of frequency channels to AAUs, frequency channels C1, C3, C5, C9 are assigned to AAU 120-1, frequency channels C2, C4, C7, C10 are assigned to AAU 120-2, frequency channels C1, C3, C6, C9 are assigned to AAU 120-3, and frequency channels C2, C4, C8, C10 are assigned to AAU 120-4. In another exemplary assignment of frequency channels to AAUs, the AAU antenna elements are comprised of a first and a second antenna polarization, on AAUs 120-1 and 120-2 the frequency channels are transmitted only on the first antenna polarization, and on AAUs 120-3 and 120-4 the frequency channels are transmitted only on the second antenna polarization. In another variation of the embodiment, the AAU 120-1 and AAU 120-2 antenna elements are comprised of only one antenna polarization, and the AAU 120-3 and AAU 120-4 antenna elements are comprised of only one antenna polarization but a different polarization from that of the AAUs 120-1 and 120-2. In another exemplary assignment of frequency channels to AAUs, frequency channels C1 and C3 are assigned to the first polarization of AAU 120-1, frequency channels C5 and C9 are assigned to the second polarization of AAU 120-1, frequency channels C2 and C4 are assigned to the first polarization of AAU 120-2, frequency channels C6 and C10 are assigned to the second polarization of AAU 120-2, frequency channels C1 and C3 are assigned to the second polarization of AAU 120-3, frequency channels C7 and C9 are assigned to the first polarization of AAU 120-3, frequency channels C2 and C4 are assigned to the second polarization of AAU 120-4, and frequency channels C8 and C10 are assigned to the first polarization of AAU 120-4.

In one exemplary division of frequency channels on the U-NII-5 and U-NII-7 bands, four frequency channels C11-C14 cover all or part of the U-NII-7 band, and four frequency channels C15-C18 cover all or part of the U-NII-7 band. The frequency channels C1-C10 and C11-C18 are assigned to the four AAU-CDs, 120-1, 120-1, 120-3 and 120-4 of the exemplary CD-AAU configuration. In one exemplary assignment of frequency channels to AAUs, the antenna elements of AAUs 120-1 to 120-4 comprise of a first and a second polarization, frequency channels C1, C3, C5, C9 are assigned to the first polarization of AAU 120-1 and frequency channels C11-C12 and C15-C16 are assigned to the second polarization of AAU 120-1, frequency channels C2, C4, C7, C10 are assigned to the first polarization of AAU 120-2 and frequency channels C13-C14 and C17-C18 are assigned to the second polarization of AAU 120-2, frequency channels C1, C3, C6, C9 are assigned to the second polarization of AAU 120-3 and frequency channels C11-C12 and C15-C16 are assigned to the first polarization of AAU 120-3, and frequency channels C2, C4, C8, C10 are assigned to the second polarization of AAU 120-4 and frequency channels C13-C14 and C17-C18 are assigned to the first polarization of AAU 120-4. The aforementioned frequency channel division C1-C10 of the U-NII-1 to U-NII-3 bands, the frequency channel division C11-C14 of the U-NII-5 band and the frequency channel division C15-C18 of the U-NII-7 band, and the aforementioned frequency channel assignments illustrate one example of division of frequency channels among the different AAUs and antenna polarizations. A person of ordinary skill in the art will recognize that other divisions of the above U-NII bands into individual frequency channels, number of frequency channels, number of AAUs, type of antenna polarization and assignment of the frequency channels to the AAUs are also within the scope of this disclosure, without departing from the scope of the disclosure.

In some embodiments, the unlicensed/shared frequency bands U-NII-1, U-NII-2A, U-NII-2C, U-NII-3, U-NII-5 and U-NII-7 are divided into individual frequency channels, and the frequency channels will be assigned to one or more AAUs and one or two antenna polarizations. In one embodiment, both unlicensed/shared and licensed bands are divided into individual frequency channels and the frequency channels are assigned to one or more AAUs and one or two antenna polarization, where both licensed and unlicensed band frequency channels are transmitted on the same CD-AAU. In a variation of the embodiment, the frequency channels of the shared/unlicensed bands are transmitted on one set of AAUs of the CD-AAU and the frequency channels of the licensed bands are transmitted on a separate set of AAUs of the CD-AAU.

In some embodiments, a set of frequency bands are divided into a larger number of individual frequency channels than are assigned to the AAUs in a CD-AAU, wherein some frequency channels are not assigned to any AAU and are maintained in a reserve pool of frequency channels, and when a frequency channel becomes unavailable due to use by an incumbent service, the frequency channel is replaced by an available frequency channel from the reserve pool of frequency channels in the sub-stream medium paths that use the frequency channel. The above embodiments for mitigating the effect of loss of frequency channels due to the use of all or part of the frequency band by the incumbent services were described in the context of the U-NII bands. There are other frequency bands, such as the so called CBRS shared band from 3.55 to 3.7 GHz, where part of the frequency band may become unavailable due to use by an incumbent or a higher priority users. A person of ordinary skill in the art will recognize that the systems and methods described in this disclosure for mitigating loss of frequency channels in the U-NII bands are also applicable to other frequency bands, without departing from the scope of the disclosure.

### Relay Network

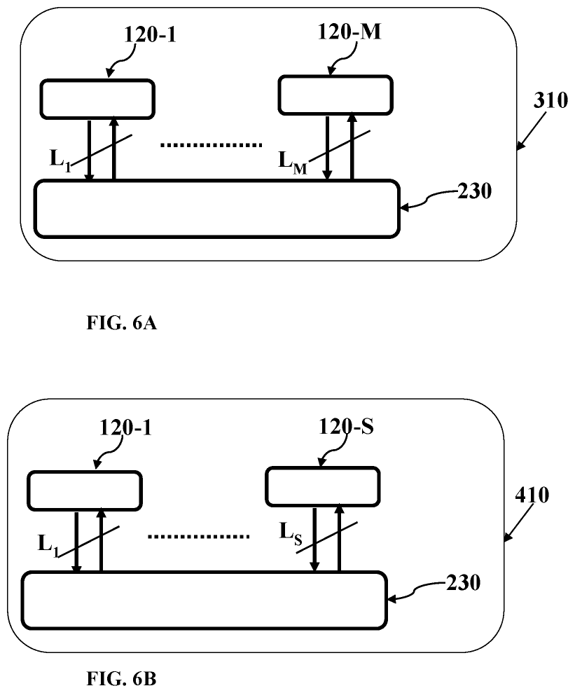

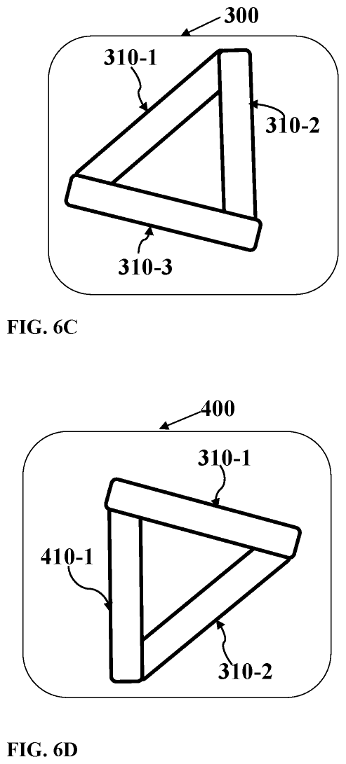

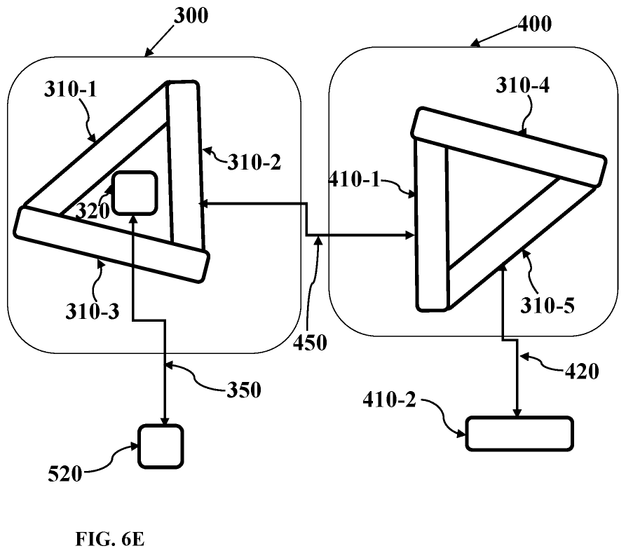

FIG. 6A illustrates a BS communications apparatus 310 comprising of a processor 230 and of M AAUs 120-m, M and m are integers ≥1. FIG. 6B illustrates a UE communications apparatus 410 comprising of a processor 230 and of S AAUs 120-s, S and s are integers ≥1. The number of individual AAUs for a UE, S, may be smaller than the number of individual AAUs, M, for a BS. The number of antenna elements of a UE AAU may also be smaller than the number of antenna elements of a BS AAU. FIG. 6C depicts a BS cell site equipment 300 comprising of three sectors, where the sectors are equipped with BS communications apparatuses 310-1, 310-2 and 310-3. FIG. 6D depicts 665 an Integrated Access and Backhaul BS (IAB-BS) cell site equipment 400 comprising of two BS communications apparatuses 300-1 and 300-2 and a UE communications apparatus 410-1. A person of ordinary skill in the art will recognize that the BS cell site equipment and the IAB-BS cell site equipment may comprise of only two sectors or of more than three sectors, without departing from the scope of the disclosure. FIG. 6E is a depiction of a single link relay network, wherein the internet 670 connection link 350 to the BS cell site equipment 300 is established via the backhaul subsystem 320 of the BS cell site equipment 300 and the backhaul apparatus 520. The BS communications apparatus 310-2 of the BS cell site equipment 300 provides a backhaul link 450 to the IAB-BS cell site equipment 400 via the UE communications apparatus 410-1 of the IAB-BS cell site equipment 400. The communications apparatuses 310-4 and 310-5 of the IAB-BS cell site equipment 400 use the UE 675 communications apparatus 410-1 as backhaul to the internet and provide connectivity to the UEs in their coverage area such as UE 410-2.

In one embodiment, the BS cell site equipment 300 and the IAB BS cell site equipment 400 use TDD. The communications apparatuses 310-1, 310-2, and 310-3 of the BS cell site equipment 300 allocate X % of the time to the downlink from the BS communications apparatus 310-2 to the UE 680 communications apparatus 410-1, and 100%-X % of the time to the uplink from the UE communications apparatus 410-1 to the BS communications apparatus 310-2. When the communications apparatuses 310-j of the BS cell site equipment 300 are transmitting on the downlink, the BS communications apparatuses 310-4 and 310-5 and UE communications apparatus 410-1 of the IAB-BS cell site equipment 400 are receiving on the uplink, implementing reverse TDD cycle between the BS cell site equipment 300 and the IAB-BS cell site equipment 400. The advantage of the reverse TDD between the BS cell site equipment 300 and the IAB-BS cell site equipment 400 approach is to avoid interference from the downlink of the communications apparatuses 310-4 and 310-5 into the receiver of the UE communications apparatus 410-1. In another embodiment, the BS cell site equipment 300 and the IAB-BS cell site equipment 400 use FDD, wherein two different frequency channels F1 and F2 are used, respectively, on the downlink and the uplink from/to the BS communications apparatuses 310-1, 310-2 and 310-3. Frequency channels F2 and F1 are used, respectively, on the downlink and the uplink from/to the IAB-BS communications apparatuses 310-4, 310-5 and the UE communications apparatus 410-1. In other words, when the communications apparatuses 310-j of the BS cell site equipment 300 are transmitting on frequency F1 and are receiving on F2, the BS communications apparatuses 310-4 and 310-5 and the UE communications apparatus 410-1 of the IAB-BS cell site equipment 400 are receiving on frequency F1 and are transmitting on frequency F2, resulting in a reverse FDD between the BS cell site equipment 300 and the IAB-BS cell site equipment 400. The advantage of the reverse FDD approach is to avoid interference from the downlink of the communications apparatuses 310-4 and 310-5 into the receiver of the UE communications apparatus 410-1 and vice versa. The two-node relay network of FIG. 6E can be extended to more than two nodes, wherein each two neighboring nodes use the time in a TDD system, or the frequency channels in an FDD system, in a reverse manner as described above. In another embodiment, the IAB-BS cell site equipment 400 communications apparatuses 310-4 and 310-5 use a different set of frequency channels than those used by the BS cell site equipment 300 communications apparatuses 310-1, 310-2 and 310-3.

What is claimed is:

1. A communications apparatus for providing wireless broadband access, comprising:
a set of one or more Active Antenna Units (AAUs);
an AAU of the set of one or more AAUs comprising at least one antenna element;
each antenna element of the AAU of the set of one or more AAUs comprising at least one antenna polarization;
each antenna element of the AAU of the set of one or more AAUs is connected to a radio subsystem;
the radio subsystem is connected to a processor;
each of a set of one or more frequency bands is divided into a set of one or more frequency channels;
the processor converts a user data stream into a sequence of data packets;
the processor de-multiplexes the sequence of data packets into one or more data packet sub-streams;
a transmit medium unit comprising three elements, one frequency channel, one antenna polarization and one AAU;
a sub-stream medium path comprising at least one transmit medium unit;
a plurality of sub-stream medium paths; and
each data packet sub-stream is transmitted on a different sub-stream medium path of the plurality of sub-stream medium paths.

2. Apparatus of claim 1, wherein the processor further comprises of a baseband processor, and the baseband processor searches for existence of an extraneous signal on a frequency channel.

3. Apparatus of claim 2, wherein the communications apparatus stops transmitting on the frequency channel if the extraneous signal is detected.

4. Apparatus of claim 1, wherein the communications apparatus stops transmitting on a frequency channel if an automatic frequency coordination system determines that there will be harmful interference to an incumbent service if the communications apparatus transmits on the frequency channel.

5. Apparatus of claim 3, wherein the communications apparatus replaces the frequency channel with an available frequency channel in a reserve pool of frequency channels.

6. Apparatus of claim 4, wherein the communications apparatus routes a data packet of the sequence of data packets to a sub-stream medium path that does not use the frequency channel.

7. Apparatus of claim 3, wherein the communications apparatus routes a data packet of the sequence of data packets to a sub-stream medium path that does not use the frequency channel.

8. Apparatus of claim 1, wherein the processor further comprises of a scheduler, and the scheduler assigns data packets of the sequence of data packets to the plurality of sub-stream medium paths.

9. Apparatus of claim 1, wherein at least one frequency channel of the set of one or more frequency channels of a frequency band of the set of one or more frequency bands is assigned to at least one AAU of the set of one or more AAUs.

10. Apparatus of claim 9, wherein a frequency channel of the set of one or more frequency channels of a frequency band of the set of one or more frequency bands is assigned to only one antenna polarization of an AAU of the set of one or more AAUs.

11. A method for providing wireless broadband access, the method comprising:
transmitting on a set of one or more Active Antenna Units (AAUs);
transmitting on at least one antenna element of an AAU of the set of one or more AAUs;
transmitting on at least one antenna polarization of the at least one antenna element;
connecting each antenna element of the AAU of the set of one or more AAUs to a radio subsystem;
dividing each of a set one or more frequency bands into a set of one or more frequency channels;
converting a user data stream into a sequence of data packets;
de-multiplexing the sequence of data packets into one or more data packet sub-streams;
forming a transmit medium unit comprising three elements, one frequency channel, one antenna polarization and one AAU;
forming a plurality of sub-stream medium paths, each of the plurality of sub-stream paths comprising at least one transmit medium unit; and
transmitting each data packet sub-stream on a different sub-stream medium path of the plurality of sub-stream medium paths.

12. Method of claim 11, further searching for existence of an extraneous signal on a frequency channel.

13. Method of claim 12, further stopping transmission on the frequency channel on which the extraneous signal is detected.

14. Method of claim 11, further stopping transmission on a frequency channel if an automatic frequency coordination system determines that there will be harmful interference to an incumbent service if a communications apparatus transmits on the frequency channel.

15. Method of claim 13, further replacing the frequency channel with an available frequency channel in a reserve pool of frequency channels.

16. Method of claim 14, further routing a data packet of the sequence of data packets to a sub-stream medium path that does not use the frequency channel.

17. Method of claim 13, further routing a data packet of the sequence of data packets to a sub-stream medium path that does not use the frequency channel.

18. Method of claim 11, further assigning data packets of the sequence of data packets to the plurality of sub-stream medium paths.

19. Method of claim 11, further assigning at least one frequency channel of the set of one or more frequency channels of a frequency band of the set of one or more frequency bands to at least one AAU of the set of one or more AAUs.

20. Method of claim 19, further assigning a frequency channel of the set of one or more frequency channels of a frequency band of a set of one or more frequency bands to only one antenna polarization of an AAU of the set of one or more AAUs.
